(19) United States
(12) Patent Application Publication
(10) Pub. No.: US 2018/0271620 A1
(43) Pub. Date: Sep. 27, 2018

(54) ORTHODONTIC APPLIANCES AND METHODS OF FABRICATING SAME

(71) Applicant: Ormco Corporation, Orange, CA (US)

(72) Inventors: Andres Rodriguez, La Verne, CA (US); Steven Benson Li, Glendora, CA (US); Benjamin Mark Nazeck, San Dimas, CA (US)

(21) Appl. No.: 15/923,087

(22) Filed: Mar. 16, 2018

Related U.S. Application Data
(60) Provisional application No. 62/474,925, filed on Mar. 22, 2017.

(51) Int. Cl. A61C 7/08; A61C 7/14; A61C 7/20; B29C 41/14; B29C 41/22; B29C 41/46

(52) U.S. Cl. CPC A61C 7/08; A61C 7/14; A61C 7/20; B29K 2075/00; B29C 41/22; B29C 41/46; A61C 2204/005; B29C 41/14

(57) ABSTRACT

A method of forming an aligner includes dipping a positive mold of teeth in a liquid material to form a liquid layer and curing the liquid layer to form a shell. The shell may include an inner layer including material from the liquid material and an outer layer including material from another liquid material. Prior to dipping the mold in the liquid material, features may be coupled to the layer. The features may be selected from the group consisting of an archwire, a sensor, and a bracket. The mold includes model teeth and a gingival margin on a base. Dipping may be to a predefined depth. A fluid level of the material is positioned proximate the gingival margin. The fluid level may define the edge of the shell. A set of aligners including at least one aligner having an edge that defines an opening and the edge is as-formed.

### CROSS REFERENCE TO RELATED APPLICATIONS

This application claims the benefit of U.S. Provisional Patent Application Ser. No. 62/474,925 filed on Mar. 22, 2017, the disclosure of which is expressly incorporated by reference herein in its entirety

### TECHNICAL FIELD

The invention relates generally to orthodontic appliances, and more particularly, to orthodontic aligners and methods of fabricating orthodontic aligners.

### BACKGROUND

Orthodontic appliances represent a principal component of corrective orthodontic treatments devoted to improving a patient's malocclusion. In one type of orthodontic treatment, a clinician secures an orthodontic bracket to each tooth, such as with an adhesive. The clinician then inserts an archwire into each of the orthodontic brackets. The archwire interacts with the orthodontic brackets to apply corrective forces that coerce the teeth to move into orthodontically correct positions. Conventional orthodontic brackets are ordinarily formed from stainless steel, which is strong, nonabsorbent, weldable, and relatively easy to form and machine. Patients undergoing orthodontic treatment using metal orthodontic brackets may be embarrassed by the visibility of metal, which is not cosmetically pleasing.

In accordance with an alternative method of orthodontic treatment, a series of clear, removable aligners may be successively worn by the patient to improve the patient's malocclusion. Each aligner may be made of a polymer and is selectively removable by the patient. The aligners are not themselves adhesively secured to the patient's teeth and may be removed at any time. That is, the patient can simply pull the aligner off their teeth at will. The patient may therefore remove the aligner prior to eating or prior to other events. Unlike conventional orthodontic brackets, each aligner is placed over the patient's teeth and may encapsulate each tooth.

During this type of orthodontic treatment, a practitioner prescribes a series of aligners. Each aligner in the series may be designed to move one or more teeth over a portion of the entire distance towards the final, desired position. The movement is therefore incremental according to a prescription. The degree of movement produced by any single aligner is limited. By design, one aligner moves the teeth to one position and is then removed, and the next aligner moves the teeth from proximate that end position to a next position that may be closer to the final, desired position. In this way, collectively, the series of aligners moves one or more of the patient's teeth from their original position to an aesthetically pleasing position according to a prescription. This treatment therefore requires a series of custom aligners to be made for each patient.

In one process for fabricating aligners, a computer model of the patient's teeth may be used. Using the model, the clinician may determine the prescription by which all the teeth ultimately arrive at their aesthetically pleasing positions. The prescription may then determine incremental movements of the patient's teeth. Each of these movements may be attributed to a single one of the aligners in the series. This type of orthodontic treatment may require multiple aligners. Each aligner requires a unique positive mold. The fabrication of aligners is therefore a tedious, cost intensive process.

For example, to manufacture each aligner, a polymer sheet may be thermoformed over a positive mold of the tooth. In subsequent processes, the deformed sheet is trimmed to remove excess plastic that may result from the thermoforming process. In addition, sharp edges that result from the trimming process, which might contact and irritate the gingiva, are smoothed via another post-forming process, such as tumbling. The manufacturing cost for each aligner is multiplied by each subsequent processing step.

Furthermore, current processes create problems. For example, trimming each aligner requires accuracy, because inaccurate trimming may lead to patient discomfort. This discomfort is generally caused by contact between a poorly trimmed edge of the aligner and the patient's gingiva, which causes irritation, potentially inflammation, and bleeding. In this situation, the patient is therefore less likely to adhere to the scheduled orthodontic treatment.

While generally successful, there is a need for improved orthodontic appliances, including improved aligners and the methods for making aligners that overcome these and other deficiencies described above.

### SUMMARY

The present invention overcomes the foregoing and other shortcomings and problems heretofore known for orthodontic appliances and methods of making those orthodontic appliances. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a method of forming an aligner comprises dipping a positive mold of teeth in a first liquid material to form a first liquid layer and curing the first liquid layer to form a shell having one or more cavities configured to receive corresponding teeth and an edge that defines an opening.

In one embodiment, the method further includes dipping the positive mold in a second liquid material. The shell includes an inner layer including material from the first liquid material and an outer layer including material from the second liquid material.

In one embodiment, the second liquid material is different than the first liquid material.

In one embodiment, dipping the positive mold in the second liquid material occurs after curing the first liquid layer.

In one embodiment, the method further comprises prior to dipping the positive mold in the second liquid material, coupling one or more features to the cured first layer. In one embodiment, the one or more features are selected from the group consisting of an orthodontic archwire, a sensor, and an orthodontic bracket.

In one embodiment, the positive mold includes one or more model teeth and a model gingival margin in a predetermined arrangement on a base and dipping the positive mold is to a predefined depth to which a fluid level of the first liquid material is positioned proximate the gingival margin.

In one embodiment, the fluid level defines the edge of the shell.

In one embodiment, the method further comprises forming a non-stick coating on the positive mold prior to dipping the positive mold in the first liquid material.

In one embodiment, the method further comprises fabricating the positive mold via rapid prototyping.

In one embodiment, the method further comprises curing the first liquid layer on the positive mold to form the inner layer.

In one embodiment, the method further comprises curing the second liquid layer after curing the inner layer to form the outer layer.

In one embodiment, the outer layer has a higher hardness than the inner layer.

In accordance with the principles of the present invention, a set of aligners for use in orthodontic treatment comprises at least one aligner including a shell having a plurality of cavities each configured to fit over a corresponding one of a patient's teeth and an edge that defines an opening and being positioned proximate the patient's gingival margin, the edge being as-formed.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a perspective view of a multi-layer aligner made in accordance with one embodiment of the invention.

FIG. 2A is a schematic diagram of the formation of a release coating on a positive mold of teeth in accordance with one embodiment of the invention.

FIG. 2B is a schematic diagram of the formation of a first aligner layer on the positive mold of FIG. 2A.

FIG. 2C is a side view of a feature being attached to the first aligner layer of FIG. 2B according to one embodiment of the invention.

FIG. 2D is a schematic diagram of the formation of a second aligner layer over the first aligner layer of FIG. 2B.

FIG. 2E is a side view of a multi-layer aligner formed using the process shown in FIGS. 2A-2D.

FIG. 3 is a cross-sectional view of an aligner of FIG. 2E taken along section line 3-3.

FIG. 4 is a perspective view of the multi-layer aligner of FIG. 2E showing the removal of the aligner from the positive mold of FIG. 2A.

FIG. 5A is a view of a tool for forming more than one multi-layer aligner at a time in accordance with one embodiment of the invention.

FIG. 5B is a view of the tool of FIG. 5A showing positive molds partially submerged in a liquid material.

### DETAILED DESCRIPTION

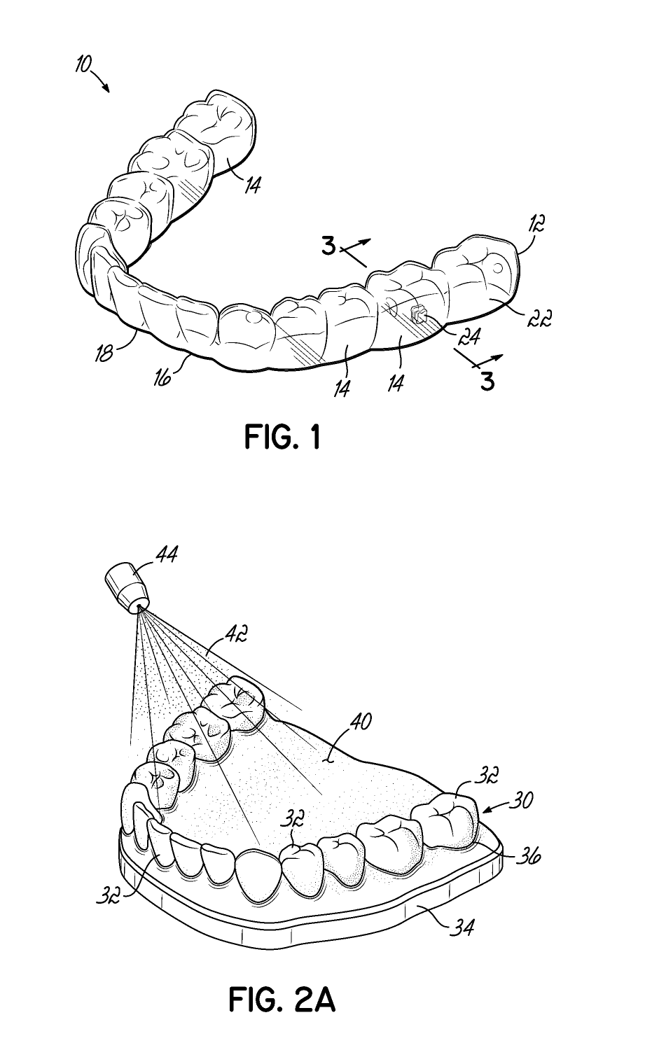

Referring to the drawings, and to FIG. 1 in particular, an orthodontic appliance in the exemplary embodiment is an aligner 10 capable of moving teeth. In particular, the orthodontic aligner 10 may move one or more teeth from one orientation to another. Overall, the aligner 10 moves the teeth toward an orientation whereby the teeth ultimately are positioned at their final orthodontically correct and aesthetic positions. Tooth movement may be according to a predetermined treatment plan.

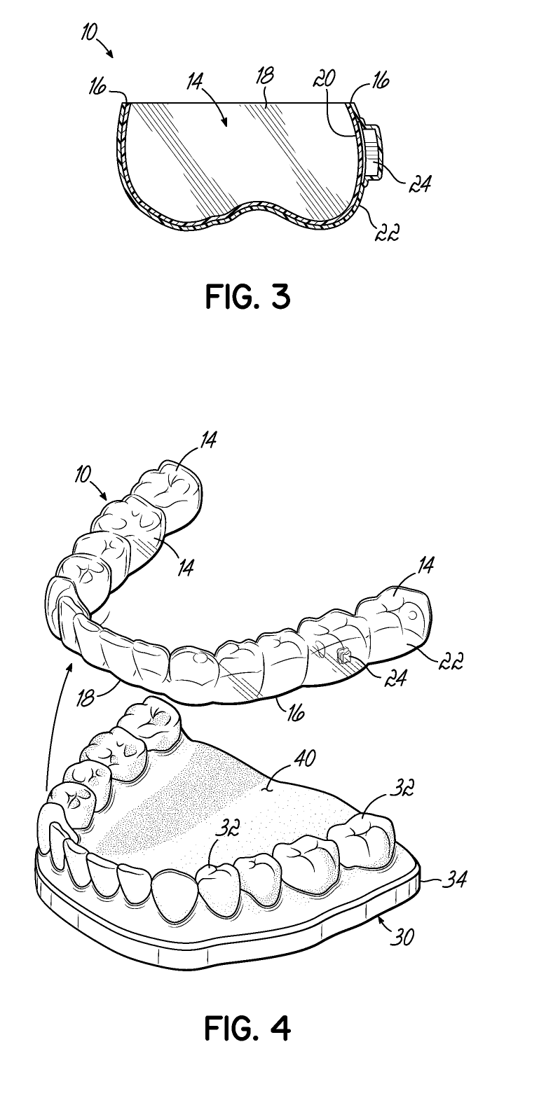

As shown, the aligner 10 includes a hollow shell 12 that is configured to encapsulate one or more crowns of a patient's teeth. The shell 12 is formed with a plurality of cavities 14 that collectively define an edge 16. The edge 16 in turn defines an opening 18 in the shell 12. Each cavity 14 is shaped to receive a specific one of the patient's teeth through the opening 18 such that the edge 16 is positioned proximate the patient's gingiva. With reference to FIGS. 1 and 3, in one embodiment, the shell 12 may be made of an elastic material in one or more layers. As shown best in FIG. 3, an exemplary shell 12 may include an inner layer 20 and an outer layer 22. Embodiments of the present invention, however, are not limited to shells 12 with two layers, as the shell 12 may include a single layer or more than two layers.

In one embodiment, the aligner 10 may include an additional feature 24. The additional feature(s) 24 may improve the clinical efficacy of the aligner 10. In the exemplary embodiment, the additional feature 24 is an orthodontic bracket. Other additional features may include, without limitation, an orthodontic archwire, one or more orthodontic buttons, and one or more sensors. Orthodontic buttons may be used in conjunction with a rubber band during the orthodontic treatment. As shown, the additional feature 24 may be encapsulated between the inner layer 20 and the outer layer 22.

During orthodontic treatment, the aligner 10 is selectively positionable over the patient's teeth and may fit tightly at least partly due to slight differences in the position of one or more of the cavities 14 relative to the corresponding tooth. The aligner 10 may elastically deform while positioned over the patient's teeth. The elastic deformation may be observable as a measurable amount of bulk or localized strain in the shell 12. The strain in the shell 12 produces pressure on the teeth as the shell 12 attempts to return to an un-strained condition or a similar reduced strain configuration. The forcible contact with the aligner 10 may move the patient's teeth toward a predetermined position according to a clinician's treatment plan.

In one embodiment of the invention, a set of aligners (not shown) may include one or more aligners 10. During orthodontic treatment, each of the aligners in the set may differ slightly so that they each provide slightly different movement of the teeth. The patient utilizes the individual aligners in a predetermined sequence to complete orthodontic treatment. Accordingly, each aligner in the series may move one or more teeth a prescribed amount. Cumulatively, these individual amounts may result in complete treatment of the patient's malocclusion.

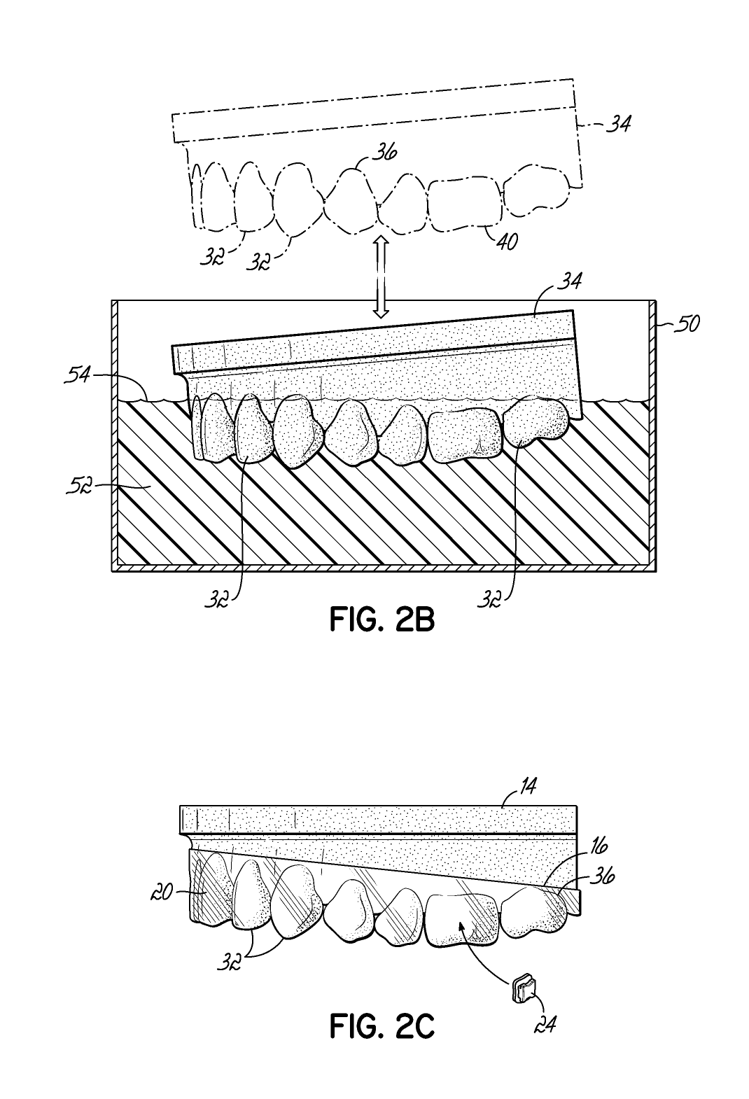

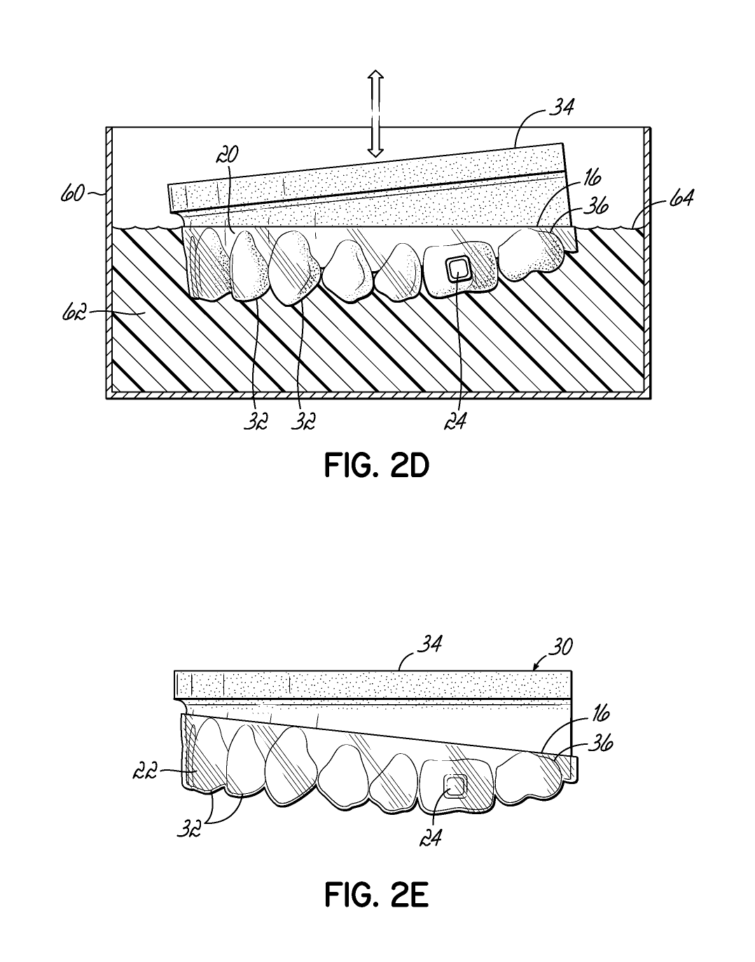

With reference to FIGS. 2A-2E, in one embodiment of the invention, a method for manufacturing the aligner 10 is shown. Generally, according an exemplary dip molding process, described below, a mold of the patient's teeth is at least partially submerged in a liquid polymer. When the mold is removed from the liquid polymer, a residual layer of the liquid polymer coats the mold. The coating cures and is removed from the mold. The cured coating ultimately forms a portion of the aligner 10. Advantageously, aligner geometry resolution may be improved relative to thermoforming processes due to the dependency of thermoforming processes on the applied vacuum as well as the mold design and the applied vacuum. Additional advantages will be apparent from the description below.

To that end, FIG. 2A shows a positive mold 30 including one or more of models of the patient's individual teeth. The positive mold 30 is ultimately used to produce the aligner 10 shown in FIG. 1 and, to that end, acts as a form over which the aligner 10 is produced. In other words, the aligner 10 replicates the shape of the positive mold 30 in a negative sense.

The positive mold 30 includes a plurality of model teeth 32 arranged in accordance with a prescription on a base 34 that may include a model gingival margin 36. In certain embodiments, the model teeth 32 may be produced from digital data available from images of the patient's teeth. By way of example only, and not limitation, an impression of the patient's teeth may be taken with a suitable dental impression material, such as polyvinylsiloxane (PVS). That dental impression may be scanned and the digital data from the scan may be imported into a computer to create a 3-D digital model of each of the patient's teeth. Alternatively, intra-oral images may be taken at the clinician's office. Those images may then be used to produce a 3-D digital model of the patient's teeth.

The 3-D digital model of the patient's teeth may be digitally manipulated to position each of the 3-D digital model teeth in a predetermined arrangement. That arrangement may then be used to manufacture the positive mold 30 according to the patient's prescription with each of the patient's teeth corresponding to one of the model teeth 32. The model teeth 32 may be individually positioned on the base 34. In that regard, a computer may be used to manipulate the images or other data sufficient to construct the positive mold 30 of the model teeth 32 in the predetermined arrangement. By way of example only, and not limitation, the data may be used to control a rapid prototyping machine, such as a stereolithography (SLA) machine, a laser sintering machine (e.g., direct metal laser sintering or selective laser sintering), a 3-D printer (e.g., fused deposition modeling machine or a polyjet machine), or via any other type of rapid prototyping mechanism to construct the positive mold 30.

In one embodiment, a rapid prototyping machine may deposit material in layers, layer by layer, to form the positive mold 30. The positive mold 30 may be made of, for example, plastic or metal such as stainless steel. In one embodiment, rapid prototyping may include depositing resin in layers based on the 3-D digital model to form the positive mold 30. Other exemplary processes for manufacturing the positive mold 30 may include pouring, injecting, or via other automated means depositing a material, such as plaster or certain types of liquid plastic, that hardens over time. While the positive mold 30 is shown being a full lower set of teeth, the positive mold 30 may be for an entire upper arch or a portion of the upper arch, such as a single model tooth 32. Similarly, the positive mold 30 may be for an entire lower arch or a portion of the lower arch, such as a single model tooth 32. Subsequently, the aligner 10 is formed over the positive mold 30 as described below.

Alternatively, the positive mold 30 may be made according to a two-step process of first generating a resin mold via a rapid prototyping machine. The positive mold 30 is then formed in the resin mold. Positive molds 30 built by rapid prototyping machines may have striations caused by the layering deposition process typical of this style of rapid prototyping. The striations may cause jagged grooves or other defects in the aligners generated directly from the positive mold fabricated by rapid prototyping. Such striations may be significantly reduced or eliminated when the positive mold 30 is fabricated with the two-step process. Advantageously, the positive mold 30 from a two-step process may be characterized by a relatively smooth surface, which may, in turn, be used in the production of aligners 10 that are similarly relatively smooth. The likelihood of trapping of food and bacteria between the aligner and the teeth is reduced when the surface of the aligners is smooth. Such a process is described in U.S. patent application Ser. No. 14/318,393, the disclosure of which is incorporated herein in its entirety.

Following fabrication of the positive mold 30 and with reference to FIG. 2A, in one embodiment, a release coating 40 may be placed over the positive mold 30 to facilitate removal of the aligner 10 once it is formed on the positive mold 30. In one embodiment, the release coating 40 is Teflon or another similar non-stick coating. The release coating 40 may be a lubricious, low friction, and/or hydrophilic material, which may inhibit bonding of the aligner 10 with the positive mold 30 and so may facilitate separation of the aligner 10 from the positive mold 30. As shown, the release coating 40 may be formed by spraying a liquid 42 that forms the release coating 40, such as Teflon, from a nozzle 44 onto the positive mold 30. The release coating 40 may cover each of the model teeth 32, the base 34, and the model gingival margin 36.

With reference to FIG. 2B, the positive mold 30 may be lowered into a reservoir 50 of liquid material 52. As shown, the positive mold 30 is at least partially submerged in the liquid material 52. The positive mold 30 may be submerged so that a fluid level 54 is at or near the model gingival margin 36. In other words, the positive mold 30 may be submerged to a depth sufficient to cover only each of the model teeth 32. The majority of each model tooth 32 may be covered by the liquid material 52. Full coverage of each model tooth 32 may not be required. The fluid level 54 to which the positive mold 30 is submerged in the liquid material 52 may define at least a portion of the edge 16 of the aligner 10. Advantageously, controlling submersion depth, that is, the relative position of the fluid level 54 and the model gingival margin 36, may reduce post formation trimming of the aligner 10. In that regard, in an embodiment, the edge 16 of the aligner 10 may be an as-formed edge. The as-formed edge 16 may not require machining to remove any excess material from the aligner 10. In an embodiment, portions of the edge 16 of the aligner 10 may be an as-formed edge, which may not require machining. Other portions of the edge 16 may be trimmed so that the edge 16 generally follows the model gingival margin 36. However, embodiments of the invention are not limited the submersion depth show, the positive mold 30 may be submerged in the liquid material 52 to other depths. For example, the entire positive mold 30, including the base 34, may be submerged in the liquid material 52.

With continued reference to FIGS. 2B and 2C, following being submerged, the positive mold 30 is withdrawn from the reservoir 50. A layer of the liquid material 52 may cling to the positive mold 30 and so form a liquid coating over a portion of the positive mold 30, such as over one or more of the model teeth 32. The liquid coating may be cured to form a layer of the aligner 10. In FIG. 2B, after curing, the inner layer 20 may be formed.

In one embodiment, the liquid material 52 is liquid polyurethane, which is a combination of polyurethane and a solvent, such as tetrahydrofuran. When the positive mold 30 is withdrawn from the reservoir 50, liquid polyurethane coats a portion of the positive mold 30. The tetrahydrofuran solvent flashes off or evaporates from the liquid coating during a drying or a curing process. As the solvent is released, the remaining polyurethane in the coating hardens to form the inner layer 20 of the aligner 10. During curing, the coating may shrink. The temperature of the curing process may affect the degree to which the coating layer shrinks. The curing process may be at a temperature of, for example, 120° F.

Referring to FIG. 2C, one or more additional features may be incorporated into the aligner 10 during or following curing of the liquid coating. In the exemplary embodiment, an orthodontic bracket 24 is adhered to the inner layer 20 following curing. In one embodiment, an additional feature 24 in the form of an orthodontic bracket may be glued to the inner layer 20 using, for example, cyanoacrylate in a separate process.

With reference to FIG. 2D, in one embodiment, manufacturing the aligner 10 may further include dipping the positive mold 30 and the inner layer 20 into a reservoir 60 of liquid material 62 to form a second layer, which may ultimately form the outer layer 22. The liquid material 62 for the second layer may be the same as or different from the liquid material 52 that forms the inner layer 20 depending on the intended orthodontic treatment. The positive mold 30 may be submerged so that a fluid level 64 is at or near the model gingival margin 36. The submersion depth may be controlled in a manner similar to that used in the formation of the inner layer 20. In other words, the outer layer 22 may be formed to have the same dimensions as the inner layer 20.

When the positive mold 30 is raised from the reservoir 60, a layer of the liquid material 62 may cling to the inner layer 20 and any additional features (e.g., orthodontic bracket 24) and so form a coating of liquid material over the inner layer 20 and over those additional features. When the solvent flashes off or evaporates from the coating of liquid material 62 during a drying or curing process, the coating hardens to form the outer layer 22 as shown in FIG. 2E. While curing processes for each layer may occur immediately after a prior dipping process, it will be appreciated that each liquid coating may not be fully cured prior to a second or subsequent dipping process. Multiple uncured layers may be cured with a single curing process.

In view of the multiple layers, additional features may be incorporated into the aligner 10 by encapsulating them between any two layers of the aligner 10. For example, as shown in FIG. 3, the orthodontic bracket 24 is secured between the inner layer 20 and the outer layer 22. In an aligner 10 in accordance with the present invention, any appropriate biocompatible (e.g., non-toxic, etc.) material may be used for the layers 20, 22. Materials suitable for use include, without limitation, polymers such as polyurethanes and polyvinyl chloride. Solvents suitable for liquefying the aligner material include, without limitation, tetrahydrofuran (THF) and dimethylacetamide (DMAC).

In an embodiment, relatively hard and relatively soft versions of the same material may be used as different layers (or different regions of the same layer) in the aligners described herein. One or both of the dipping processes shown in FIGS. 2B and 2D may be repeated multiple times to form the aligner 10 having a corresponding number of layers.

As described above, the inner layer 20 and the outer layer 22 may be formed from different liquid materials and so the layers 20 and 22 may differ in composition. Each layer 20 or 22 may have different properties (e.g., stiffness, elasticity, hardness, surface friction, hydrophobicity, etc.) from each of the other layers due at least in part to the different materials. The combination of properties from multiple layers may enhance wear resistance while also being more comfortable and more accurately worn by the patient. For example, the outer-most layer (e.g., outer layer 22 in FIG. 3) may have a higher hardness than the inner layer(s) (e.g., inner layer 20 in FIG. 3) to provide more durability against chewing, biting, etc., during use. This may mean that the outer layer 22 is more rigid than the inner layer 20 and so the outer layer 22 provides the bulk of the mechanical properties of the aligner 10. That is, the outer layer 22 may provide the desired elastic stress-strain response and the inner layer 20 may provide the necessary patient comfort. Other material differences may provide other advantages.

Alternatively, or in addition, the outer layer 22 may be less sensitive to elevated temperature such that the outer layer 22 enhances the resistance of the aligner 10 to deformation or relaxation distortion when it contacts hot fluids and hot food. Further, the inner layer(s) can be softer than the outer layer to make the aligner 10 more comfortable for the patient to wear. The softer inner layer may also allow wider contact area with the patient's teeth, making it easier to fit to the patient's teeth. The fit of a softer inner layer may also relax manufacturing tolerances. The relative hardness of the different layers reflects comparative measure of the surface hardness, structural hardness, elasticity and/or stiffness of a material. For example, in one embodiment, the material used for the outer layer 22 may have a Shore durometer ranging from about 40D to about 60D, and the material used for the inner layer 20 may have a Shore durometer ranging from about 60A to about 80A.

With reference to FIG. 4, the aligner 10 may be separated from the positive mold 30 and may be prepared for further processing. In one embodiment, the aligner 10 may be separated from the positive mold 30 using fluid pressure. For example, air, water, or a water and alcohol mixture may be forced in a gap between the aligner 10 and the positive mold 30 to aid in separating the aligner 10 from the positive mold 30. A water and alcohol mixture may aid in preventing bioburden from growing on the aligner 10 or the positive mold 30.

In one embodiment, the aligner 10 requires less post processing compared to a thermoformed aligner. In that regard, dipping the positive mold 30 in a liquid material may ultimately provide a smooth edge 16 and reduce or eliminate additional post formation processing. For example, a tumbling process by which edges may be smoothed may not be needed. Moreover, dip molding may improve geometry resolution compared to thermoforming an aligner.

In one embodiment, the aligner 10 may be one of a series of aligners that are prescribed to treat a patient's malocclusion or a portion thereof. To that end, additional positive molds may be manufactured according to the patient's orthodontic treatment plan. Each of the positive molds may be dipped according to FIG. 2B or FIG. 2D. Additional dipping may also be conducted according to FIG. 2D or FIG. 2B. Each dipping process may be unique in the number of layers and differences in material types. Further, aligners may incorporate decorative or identification features, such as patient identification numbers, logos, and coloring in the fabricated aligner material providing an appearance of whiter, corrected teeth.

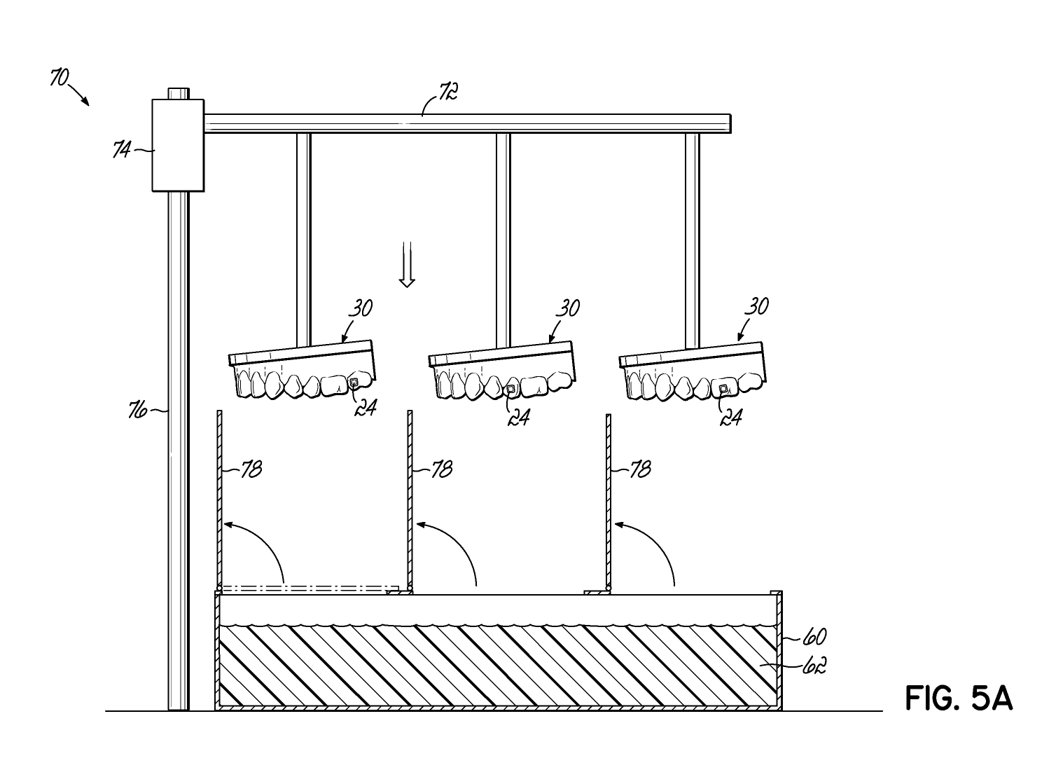

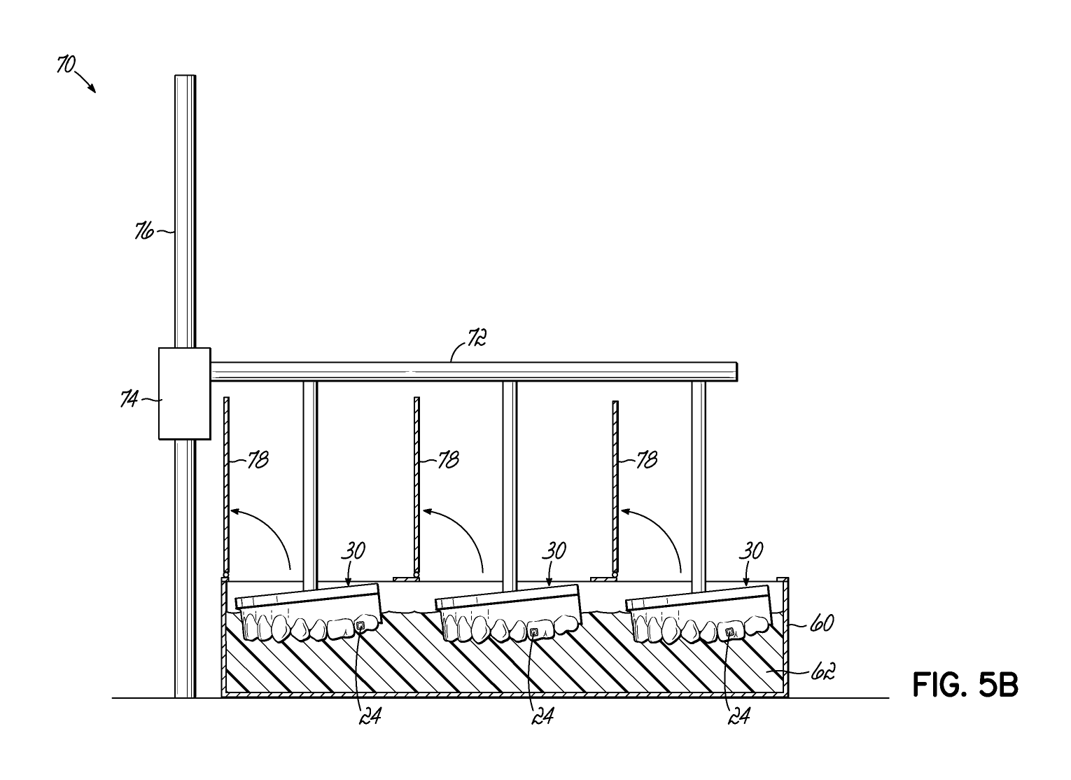

With reference to FIGS. 5A and 5B, in an embodiment, multiple aligners 10 may be formed at a time. A tool 70 is configured to hold more than one positive mold 30. The positive molds 30 may be used to form the series of aligners to be used throughout a patient's orthodontic treatment plan. The tool 70 includes an arm 72 that is capable of supporting the positive molds 30. The arm 72 extends from a connector 74, which is slidable along a support pole 76. As the arm 72 lowers on the support pole 76, the positive molds 30 are submerged into the liquid material 62. The reservoir 60 may include one or more doors 78 that may be closed to reduce amount of evaporation of the solvent from the liquid material 62. As shown in FIG. 5B, the doors 78 open to allow the positive molds 30 to be lowered into the liquid material 62. The positive molds 30 may be dipped according to FIG. 2B or FIG. 2D, and additional dipping may also be conducted according to FIG. 2D or FIG. 2B.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. A method of forming an aligner comprising:
dipping a positive mold of teeth in a first liquid material to form a first liquid layer; and
curing the first liquid layer to form a shell having one or more cavities configured to receive corresponding teeth and an edge that defines an opening.

2. The method of claim 1, further including dipping the positive mold in a second liquid material, the shell including an inner layer including material from the first liquid material and an outer layer including material from the second liquid material.

3. The method of claim 2, wherein the second liquid material is different than the first liquid material.

4. The method of claim 2, wherein dipping the positive mold in the second liquid material occurs after curing the first liquid layer.

5. The method of claim 2, further comprising:
prior to dipping the positive mold in the second liquid material, coupling one or more features to the cured first layer.

6. The method of claim 5, wherein the one or more features are selected from the group consisting of an orthodontic archwire, a sensor, and an orthodontic bracket.

7. The method of claim 1, wherein the positive mold includes one or more model teeth and a model gingival margin in a predetermined arrangement on a base and dipping the positive mold is to a predefined depth to which a fluid level of the first liquid material is positioned proximate the gingival margin.

8. The method of claim 7, wherein the fluid level defines the edge of the shell.

9. The method of claim 1, further comprising:
forming a non-stick coating on the positive mold prior to dipping the positive mold in the first liquid material.

10. The method of claim 1, further comprising:
fabricating the positive mold via rapid prototyping.

11. The method of claim 2, further comprising:
curing the first liquid layer on the positive mold to form the inner layer.

12. The method of claim 11, further comprising:
curing the second liquid layer after curing the inner layer to form the outer layer.

13. The method of claim 2, wherein the outer layer has a higher hardness than the inner layer.

14. A set of aligners for use in orthodontic treatment comprising:
at least one aligner including a shell having a plurality of cavities each configured to fit over a corresponding one of a patient's teeth and an edge that defines an opening and being positioned proximate the patient's gingival margin, the edge being as-formed.
